(19) United States
(12) Patent Application Publication
(10) Pub. No.: US 2026/0244680 A1
(43) Pub. Date: Aug. 20, 2026

(54) SYSTEMS AND METHODS FOR ARTIFICIAL INTELLIGENCE AGENTS FOR ARITHMETIC REASONING GENERATION

(71) Applicant: Salesforce, Inc., San Francisco, CA (US)

(72) Inventors: Kung-Hsiang Huang, Champaign, IL (US); Can Qin, Somerville, MA (US); Shafiq Rayhan Joty, San Jose, CA (US); Chien-Sheng Wu, Mountain View, CA (US)

(21) Appl. No.: 19/287,335

(22) Filed: Jul. 31, 2025

Related U.S. Application Data
(60) Provisional application No. 63/758,853, filed on Feb. 14, 2025.

(51) Int. Cl. G06F 16/532; G06N 3/045; G06N 3/08

(52) U.S. Cl. CPC G06F 16/532; G06N 3/045; G06N 3/08

(57) ABSTRACT

Embodiments described herein provide a method of arithmetic reasoning generation by an artificial intelligence (AI) agent. The method includes generating, an image containing at least one object having a target arithmetic property; generating a query relating to the target arithmetic property; generating, by a first neural network language model, a positive response and a negative response; and forming a training quadruple including the image, the query, the positive response and the negative response. The method also includes generating, by a second neural network language model a candidate response associated with a first probability that the candidate response is the positive response and a second probability that the candidate response is the negative response, training the second neural network language model; and building, at a server the AI agent employing the second neural network based language model after the training.

### CROSS REFERENCE(S)

The instant application is a nonprovisional of and claim priority under 35 U.S.C. 119 to U.S. provisional application No. 63/758,853, filed Feb. 14, 2025, which is hereby expressly incorporated by reference herein in its entirety.

### TECHNICAL FIELD

The embodiments relate generally to machine learning systems for content generation, and more specifically to systems and methods for artificial intelligence (AI) agents for arithmetic reasoning generation.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. However, AI agents based on vision language models (VLMs) often struggle with visual arithmetic tasks. For example, in an autonomous driving system, the VLM may fail to accurately generate arithmetic results, e.g., how fast will a pedestrian cross a street, etc., based on visual information, e.g., an image showing the surroundings.

### BRIEF DESCRIPTION OF THE DRAWINGS

FIG. 1 shows an exemplary application of an AI agent, according to some embodiments.

FIG. 2A shows an exemplary data pipeline for generating training data, according to some embodiments.

FIG. 2B shows examples of training quadruples, according to some embodiments.

FIG. 3 is a simplified diagram illustrating an AI agent, according to some embodiments.

FIG. 4A is a simplified diagram illustrating a computing device implementing the arithmetic reasoning generation framework described in FIGS. 1, 2A, 2B, and 3, according to some embodiments.

FIG. 4B is a simplified diagram illustrating a neural network structure, according to some embodiments.

FIG. 5 is a simplified block diagram of a networked system suitable for implementing the arithmetic reasoning generation framework described in FIGS. 1, 2A, 2B, 3, 4A, and 4B, and other embodiments described herein.

FIG. 6 is an example logic flow diagram illustrating a method of arithmetic reasoning generation based on the framework shown in FIGS. 1, 2A, 2B, 3, 4A, 4B, and 5, according to some embodiments.

FIG. 7 shows an example of a query-response template, according to some embodiments.

FIGS. 8A-8D provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

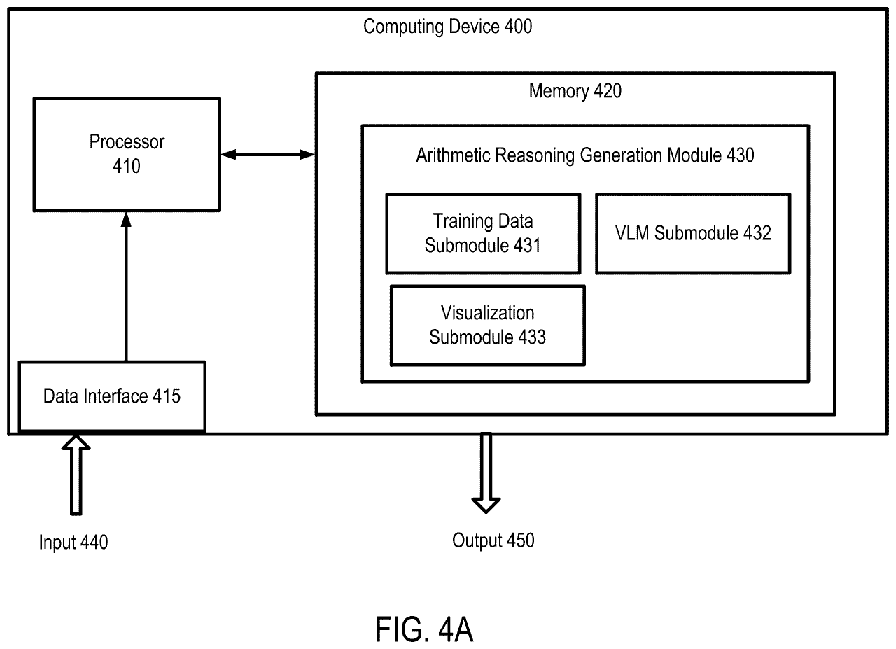

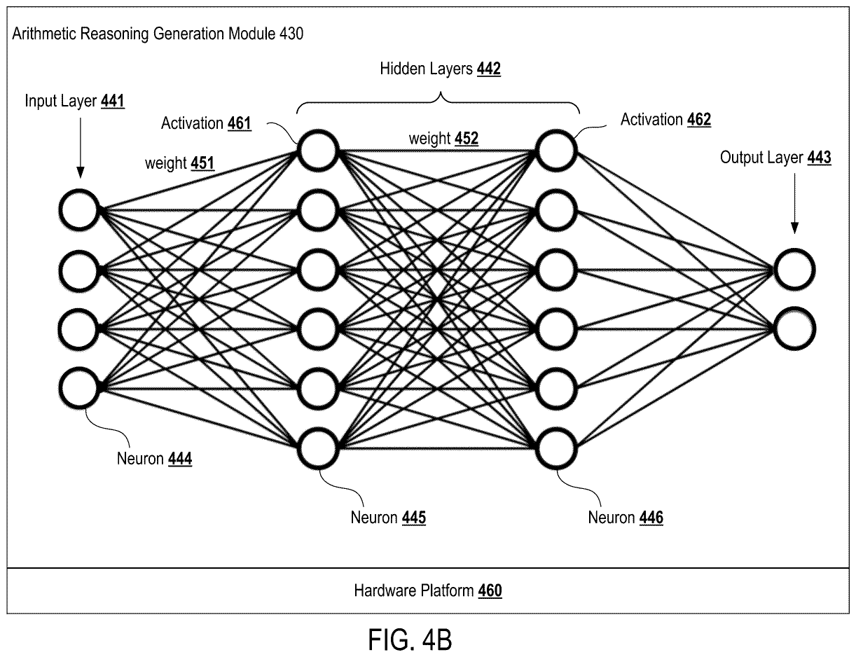

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 4B

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, a vision language model (VLM) may refer to a neural network based deep learning system designed to understand and generate information from both images (vision) and text (language), combining computer vision and natural language processing (NLP).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Visual language model (VLM) can be used for generating answers to inputs that include images and text queries. However, VLMs may lack the ability to perform tasks involving visual arithmetic inputs. For example, existing VLMs still fail to achieve accuracy in performing arithmetic tasks such as counting objects, comparing lengths, assessing angles, etc. It thus is challenging for VLMs to perform complex and practical tasks like chart understanding and geometric reasoning, e.g., for an AI agent to automatically analyze airport passenger traffic via a surveillance video streaming, to predict road traffic condition in autonomous driving, and/or the like.

In view of the need for AI agents built on VLMs with better arithmetic reasoning capabilities, embodiments described herein provide methods and systems to build an VLM-based AI agent for handling vision-language tasks that involves quantitative and/or arithmetic reasoning. Specifically, the VLM is trained or fine-tuned with a synthetic training dataset that includes quadruples of (user query, image, positive response, negative response to generate a response reasoning on the arithmetic properties depicted in an input image. The synthetic training dataset is formed based on the concepts of conservation and decentration in human cognitive ability in problem solving. For example, conservation may refer to the ability of an AI agent to recognize certain properties (e.g., length, shape, angle, etc.) in an image remain unchanged despite the transformation of the image to another image or text. Decentration may refer to the ability of an AI agent to simultaneously consider/process multiple features of an image (e.g., length, shape, and angle, etc.), rather than focusing on a single feature (e.g., length). To generate the synthetic training data, an image is first generated. Query-response pairs are then generated using a LLM with predefined templates. The training can enable the VLM to have improved recognition of invariant properties such as length, angle, and count across different visual transformations, in arithmetic reasoning. The AI agent can thus have improved performance on more complex task with better understanding of fundamental arithmetic properties.

Embodiments described herein provide a number of benefits. For example, AI agents built on these VLMs can have improved performance in various applications such as autonomous driving, surveillance video analysis, E-commerce product search, image and video captioning, visual question answering, etc. Therefore, with improved performance of these AI agents, neural network technology in content generation in these applications is improved.

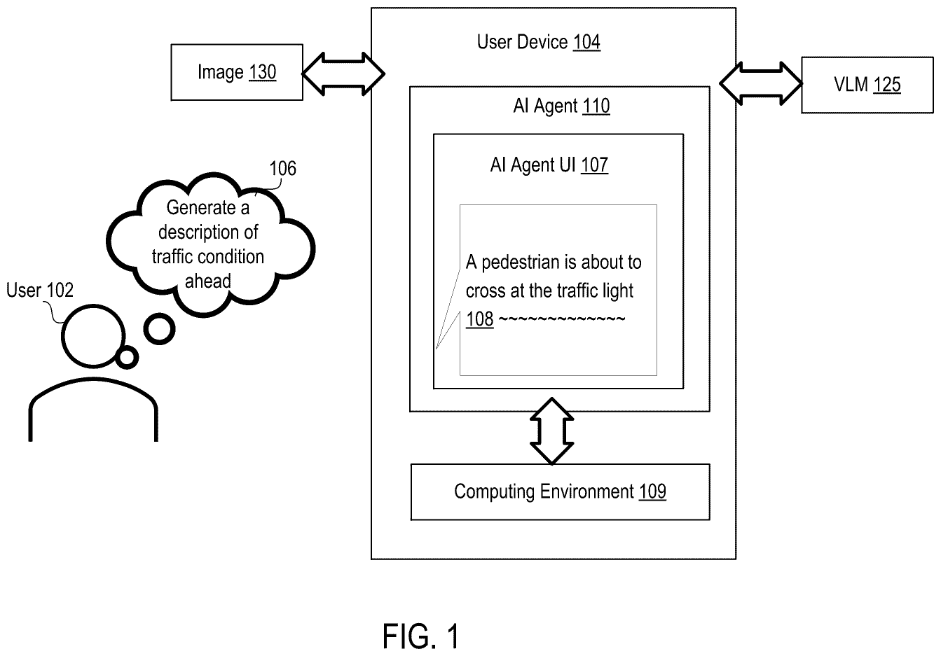

FIG. 1 shows an example operation of an VLM based AI agent, according to embodiments of the present disclosure. An VLM-based AI agent 110 may be implemented on a user device 104 to receive a user task request 106 as a natural language input, typically through a chat or command interface 107. This request 106 may range from simple queries to more complex tasks like data analysis, automation, or even generating content.

For example, the AI agent 110 may be integrated in an autonomous driving system. A VLM 125 may assist autonomous driving by analyzing real-time images of the vehicle's environment and translating visual inputs into actionable driving commands. The user 102 may ask the AI agent to “generate a description of traffic condition ahead” 106. Upon receiving the user input 106 and receiving an image 130 from on-board cameras, the VLM 125 interprets key elements such as road lanes, traffic signs, vehicles, pedestrians, and potential obstacles from the image 130. The VLM 125 may generates descriptive reasoning about the scene and issues high-level control commands-such as “slow down,” “change to left lane,” or “stop at red light”-which may be displayed at AI agent UI 107, or in an audio format. This approach enables semantic-level decision-making grounded in visual context, enhancing safety and adaptability in complex driving scenarios.

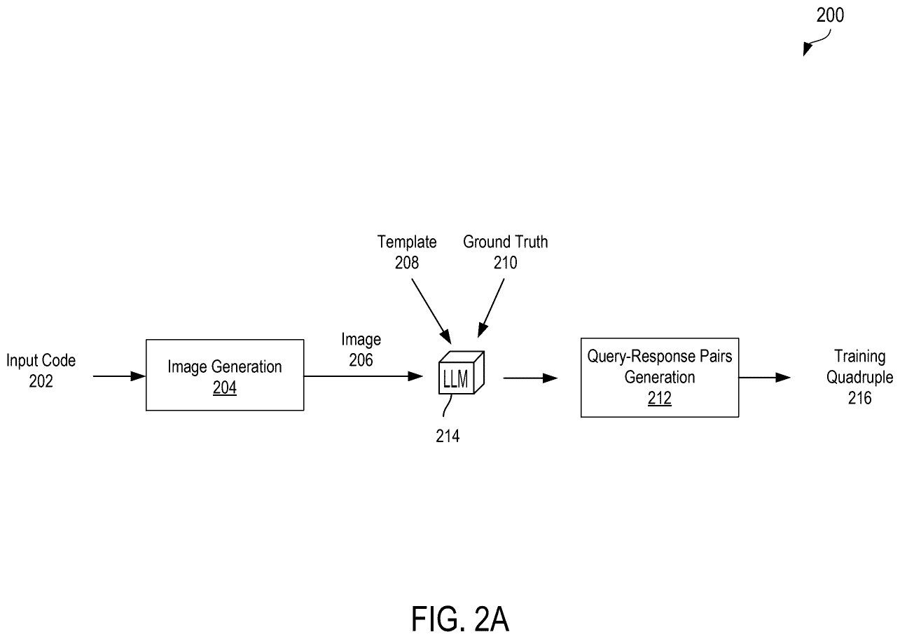

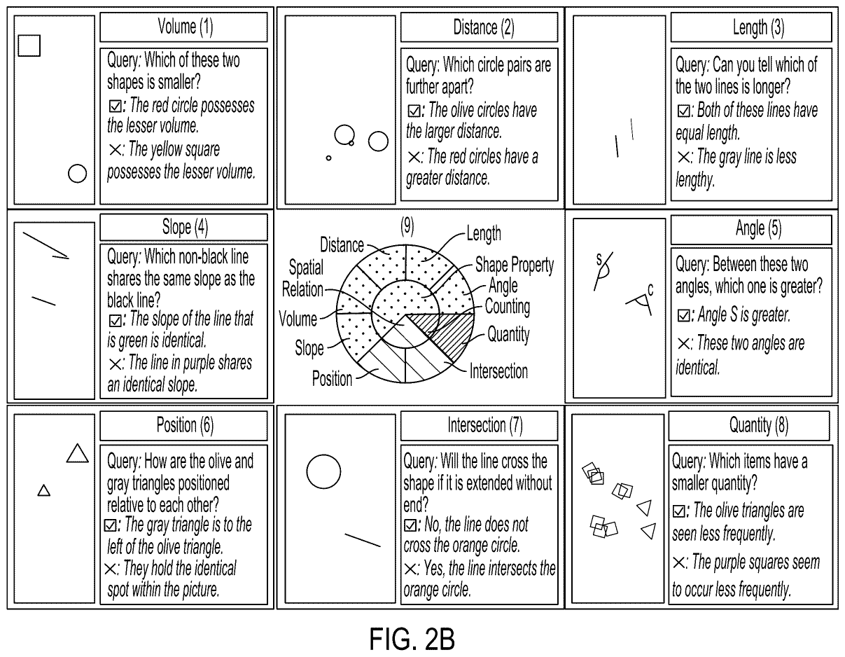

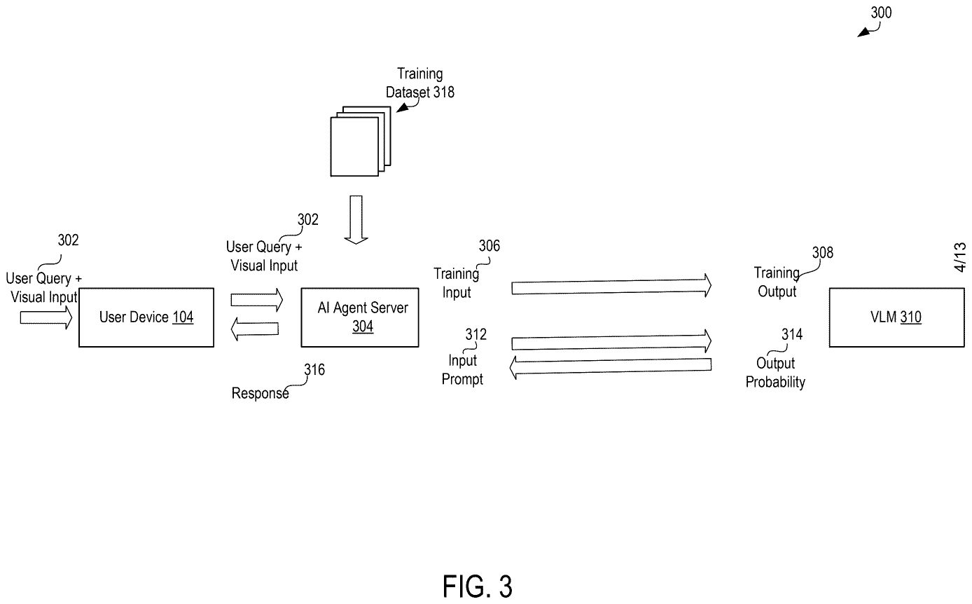

In one embodiment, the VLM 120 may be hosted at an external server, a cloud service, and/or the like that is accessible by a communication network. In a different implementation, the VLM 120 may be hosted on the user device 104. An input to the VLM 120 may comprise the task request 106 and instruction provided to the VLM 120 to guide its behavior or responses in a particular way, referred to as a “system prompt.” For example, the system prompt may contain instruction for the VLM 120 to analyze the input and respond according to the request identified in the input, and generate an output in a certain format, e.g., suggested code program, text description, etc. The VLM 120 may in turn generate a response 108 based on an input combining the task request 106 and any system prompt. Additional details on the VLM 120 generating output tokens to form the response 108 may be described in FIGS. 2A, 2B, and 3.

The response 108 may include instructions, explanations, code scripts or direct actions to address the task request 106. Such response 108 may be displayed via the AI agent interface 107 for transparency. In addition to the response 108 that describes how to fulfill the task request, the VLM 120 may generate computer-executable commands (e.g., system-level commands, Python scripts, etc.) that can directly trigger actions and/or interactions with the computing environment 109 on the user device 104.

For example, when the user 102 requests to generate a traffic condition, the VLM 120 may output a control command for the user device 104 to transmit to an autonomous vehicle so as to steer the driving of the vehicle.

However, in analyzing and understanding the input image 130, existing VLMs often have difficulties in processing arithmetic reasoning tasks such as object counting, length comparison, etc. In that case, VLM 120 may be trained on visual-language data to enhance understanding of conservation (e.g., AI agent's ability to recognize that certain properties in an image remain unchanged despite transformations of the image) and decentration (e.g., AI agent's ability to consider multiple features in an image simultaneously during processing) such that the VLM can compare and evaluate based on specific properties such as length, angle, quantity, etc. Embodiments of the present disclosure provide methods and systems to train a VLM to improve its arithmetic reasoning capabilities, and build an AI agent based on the VLM, as further described in FIGS. 2A, 2B, and C below.

FIG. 2A shows a data pipeline 200 for generating a training dataset for training a VLM, according to some embodiments. Data pipeline 200 may be part of an arithmetic reasoning generation framework.

First, image generation 204 may be performed. An image 206 may be generated programmically, allowing precise control over the properties (e.g., lengths, positions, etc.) of image 206. An input code 202 may be executed in a programming environment to generate image 206 that includes at least two objects. In some embodiments, image 206 is generated via Python.

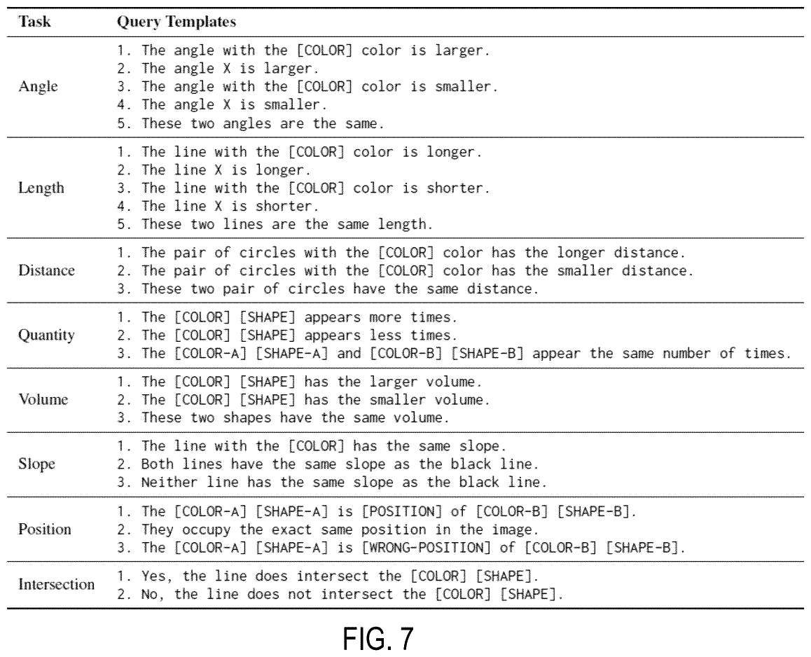

Then, query-response pairs generation 212 may be performed. An input prompt combining image 206, a template 208, the ground truth 210 of image 206, and an instruction may be provided to a LLM 214. Template 208 may include a predefined query-response template that is designed to generate queries for causing/prompting a VLM to make comparisons, identify similarities/dissimilarities, and/or reason about geometric properties. FIG. 7 shows an example of template 208. The query-response template can also be used to generate a positive response and a negative response corresponding to image 206. Based on ground truth 210, the instruction may cause LLM 214 to generate a positive response consistent with image 206 (or ground truth 210), and a negative response contradicts image 206 (or ground truth 210). In some embodiments, LLM 214 generates the positive response by populating placeholders in template 208 with the correct value(s), and the negative response by populating placeholders in template 208 with incorrect value(s). Training quadruple 216 (query, image, positive response, negative response) may be generated. In some embodiments, to improve diversity, LLM 214 or another LLM is used to generate multiple variations of each query and response. For example, the variations may include a second query, a second positive response, and a second negative response, corresponding to the same image 206. The second query and the query may differ in tokens but have the same semantic meaning. The second positive response and the positive response may differ in tokens but have the same semantic meaning, and the second negative response and the negative response may differ in tokens but have the same semantic meaning.

A training dataset may be formed including a plurality of different images covering various scenarios, and corresponding queries and responses. Each image may correspond to one or more queries of the same meaning, one or more positive responses of the same meaning, and/or one or more negative responses of the same meaning. In some embodiments, the training dataset is generated before a training process of a VLM and may be stored in a memory.

For example, image 206 may include two different angles S and C, as shown in FIG. 2B. A query may be “Between these two angles, which one is greater?” A positive response may be “The angle S is larger,” and the negative response may be “These two angles are the same.” The query, positive response, and negative response may be generated based on Task “Angle” in template 208.

FIG. 2B shows different example quadruples (1)-(8) for training quadruple 216. Each training quadruple may include a visual input (e.g., image 206), a query (or user query) prompting comparison of a specific arithmetic property (e.g., volume, distance, length, slope, angle, position, intersection, and quantity), a positive response consistent with the visual input, and a negative response that contradicts the visual input. (9) of FIG. 2B shows that quadruples (1)-(8) may cover various aspects of arithmetic properties such ss shape property (e.g., shape, volume, distance, length, angle), spatial relation (e.g., position, intersection), and counting (e.g., quantity). In some embodiments, other aspects of arithmetic properties may also be generated.

FIG. 3 is a simplified diagram illustrating an AI agent 300 in an arithmetic reasoning generation framework according to some embodiments. FIG. 3 shows the training of a VLM and the building of AI agent 300 based on the VLM. AI agent 300 may include a AI agent server 304. AI agent server 304 may be operatively connected to a user device 104 and VLM 310 through respective application programming interfaces (APIs). In some embodiments, AI agent server 304 may include a chatbot that respond to a user query and visual input 302 with a response 316.

User device 104 may be installed with an API, and may be communicatively connected to AI agent server 304 through the API. At inference stage, user device 104 may receive a user query with a visual input 302, e.g., from a user's utterance and an image/video, and may transmit user query and visual input 302 to AI agent server 304 through the API.

AI agent server 304 may train VLM 310 using the training data generated by data pipeline 200. At training stage, AI agent server 304 may retrieve training dataset 318 from a memory, locally or remotely, and may train VLM 310 using training dataset 318. Training dataset 318 may include a plurality of training quadruples 216 of (query, image, positive response, negative response), as described in FIGS. 2A and 2B. In some embodiments, AI agent server 304 trains VLM 310 using a direct preference optimization (DPO) method (Rafael Rafailov, Archit Sharma, Eric Mitchell, Christopher D Manning, Stefano Ermon, and Chelsea Finn. 2023. “Direct preference optimization: Your language model is secretly a reward model”. In Thirty-seventh Conference on Neural Information Processing Systems). DPO allows VLM 310 to learn from both positive and negative examples/responses within the preference framework.

VLM 310 may have a policy with parameters θ, denoted as a parameterized policy π_{θ}. Tre may be trained to learn conservation and decentration from contrasting responses by maximizing the conditional probability of positive responses over their negative counterparts. In some embodiments, the training dataset 318 includes a plurality of training quadruples 216, each including a user query Q an input image I, a positive response Rₚ and a negative response Rₙ. Training dataset 318 can be represented as

$$𝒟 = {\{ {( Q , I , {R}_{p} , {R}_{n} )}^{( i )} \}}_{i = 1}^{\vert 𝒟 \vert} .$$

The DPO training may minimize an objective function [symbol] denoted as Eqn(1):

$${ℒ}_{D P O} ( {π}_{θ} ; {π}_{ref} ) = - {E}_{( Q , I , {R}_{p} , {R}_{n} ) - 𝒟} [ log σ ( {r}_{Δ} ) ] ,$$

$${r}_{Δ} = β log \frac{{π}_{θ} ( {R}_{p} \vert Q , I )}{{π}_{ref} ( {R}_{p} \vert Q , l )} - β log \frac{{π}_{θ} ( {R}_{n} \vert Q , I )}{{π}_{ref} ( {R}_{n} \vert Q , l )} ,$$

where σ is the sigmoid function, π_{θ} is the parameterized policy under training, π_{ref} is the initial frozen policy, and β is a hyper-parameter that controls the deviation from π_{ref}.

During the training, AI agent server 304 may transmit training input 306 to VLM 310. Training input 306 may include training dataset 318. Upon receiving training input 306, VLM 310 may generate a training output 308 that includes first probabilities and second probabilities associated with a candidate response. VLM 310 may compute first probabilities and second policies under policies π_{θ} and π_{ref}, as shown in Eqn(1) The first probabilities (e.g., π_{θ} (Rₚ|Q, I), π_{ref} (Rₚ|Q, I)) may represent the likelihoods that the candidate response is the positive response, and the second probabilities (e.g., π_{θ}(Rₙ|Q, I), πᵣₑₛ(Rₙ|Q, I)) may represent the likelihoods that the candidate response is the negative response. VLM 310 may then compute the loss function [symbol] based on the first probabilities and second probabilities according to Eqn(1), and may backpropagate and update the parameters of π_{θ} to minimize [symbol] .

After VLM 310 is trained, VLM 310 may be used for deployment. At inference stage, User device 104 may receive user query and visual input 302. In some embodiments, the visual input includes an image and/or a video, and the user query includes natural language. AI agent server 304 may generate an input prompt 312 that combines user query and visual input 302 with an instruction, which may cause VLM 310 to generate an output probability 314 based on the user query and visual input 302. VLM 310 may transmit output probability 314 to AI agent server 304, which may generate a response 316 based on the first probability and the second probability. For example, output probability 314 may include a high first probability and a low second probability given user query and visual input 302. Response 316 may include a positive response that is consistent with the visual input. User device 104 may display response 316 to user 102.

### Computer and Network Environment

FIG. 4A is a simplified diagram illustrating a computing device implementing the arithmetic reasoning generation framework described in FIGS. 2A, 2B, and 3, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 4B.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for arithmetic reasoning generation module 430 that may be used to implement and/or emulate the systems and models, and/or to implement any of the methods described further herein. Arithmetic reasoning generation module 430 may receive input 440 such as an input to generate training data (e.g., input code 202) via the data interface 415 and generate an output 450 which may be training output 308 or output probability 314.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as input code 202, from a user via the user interface.

In some embodiments, the arithmetic reasoning generation module 430 is configured to train a VLM to learn fundamental arithmetic properties in images/videos and build an AI agent using the trained VLM. The arithmetic reasoning generation module 430 may further include a training data submodule 431, an VLM submodule 432, and a visualization submodule 433. Training data submodule 431 may be similar to data pipeline 200 in FIG. 2A). Training data submodule 431 may be configured to receive input code 202 and generate training dataset 318 that includes a plurality of quadruples of (user query, image, positive response, negative response). VLM submodule 432 may be configured to train a VLM (e.g., 310) on the training dataset, and may build an AI agent using the trained VLM by connecting to the VLM with an API. VLM submodule 432 may be similar to AI agent server 304. In some embodiments, VLM submodule 432 trains the VLM based using DPO. Visualization submodule 433 may be configured to display the output of VLM submodule 432.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 4B is a simplified diagram illustrating the neural network structure implementing the arithmetic reasoning generation module 430 described in FIG. 4A, according to some embodiments. In some embodiments, the arithmetic reasoning generation module 430 and/or one or more of its submodules 431-433 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as training dataset 318. The number of nodes (neurons) in the input layer 441 may be determined by the dimensionality of the input data (e.g., the length of a vector of training dataset 318). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4A, the arithmetic reasoning generation module 430 receives an input 440 of training dataset 318 and transforms the input into an output 450 of training output 308. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the arithmetic reasoning generation module 430 and/or one or more of its submodules 431-433 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be LLaVA-OV-0.5B, InternVL-2.5-MPO-1B, InternVL-2.5-MPO-4B, and/or the like.

In one embodiment, the arithmetic reasoning generation module 430 and its submodules 431-433 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may process the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the arithmetic reasoning generation module 430 and its submodules 431-433 may be implemented by hardware, software and/or a combination thereof. For example, the arithmetic reasoning generation module 430 and its submodules 431-433 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the arithmetic reasoning generation module 430 and its submodules 431-433 and/or any other neural network models such as LLaVA-OV-0.5B, InternVL-2.5-MPO-1B, InternVL-2.5-MPO-4B, described in FIG. 4A onto hardware platform 460, the neural network based modules 430 and its submodules 431-433 may be optimized for deployment by converting it to a suitable format, such as ONNX or TensorRT, to improve performance and compatibility. Next, depending on the size and workload requirements for modules 430 and its submodules 431-433, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the arithmetic reasoning generation module 430 and its submodules 431-433 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the arithmetic reasoning generation module 430 and its submodules 431-433 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the arithmetic reasoning generation module 430 and its submodules 431-433 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the arithmetic reasoning generation module 430 may generate, by at least one ASIC (such as a TPU, etc.) performing a multiplicative and/or accumulative operation for a neural network language model, a next token based at least in part on previously generated tokens, and in turn generate a natural language output representing the next-step action combining a sequence of generated tokens.

In one embodiment, the neural network based arithmetic reasoning generation module 430 and one or more of its submodules 431-433 may be trained by iteratively updating the underlying parameters (e.g., weights 451, 452, etc., bias parameters and/or coefficients in the activation functions 461, 462 associated with neurons) of the neural network based on the loss described in Eq. (1). For example, during forward propagation, the training data such as training dataset 318 are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding positive responses and negative responses) from the training data, to compute a loss function that measures the discrepancy between the predicted output and the expected output. For example, the loss function may be similar to Eqn. (1). Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based arithmetic reasoning generation module 430 and one or more of its submodules 431-433 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like, such as in Eqn. (1). These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

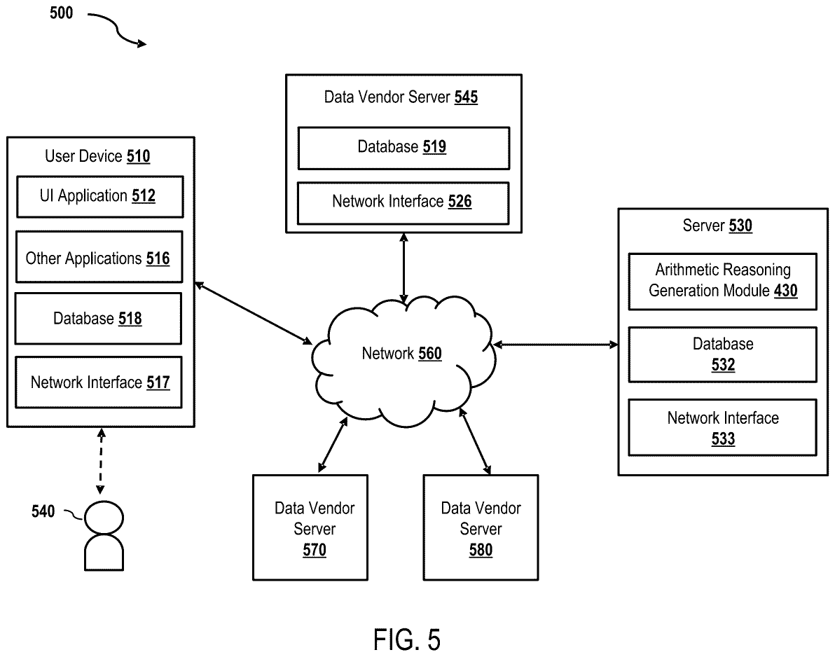

In some embodiments, arithmetic reasoning generation module 430 and its submodules 431-433 may be housed at a centralized server (e.g., computing device 400) or one or more distributed servers. For example, one or more of arithmetic reasoning generation module 430 and its submodules 431-433 may be housed at external server(s). The different modules may be communicatively coupled by building one or more connections through application programming interfaces (APIs) for each respective module. Additional network environment for the distributed servers hosting different modules and/or submodules may be discussed in FIG. 5.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating a response based an input that includes a user query and an image.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in content generation.

FIG. 5 is a simplified block diagram of a networked system 500 suitable for implementing the arithmetic reasoning generation framework described in FIGS. 2A, 2B, 3, and 4 and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating a response (e.g., 316) from the server 530 and display the message via the UI application 512. In other embodiments, user device 510 may include additional or different modules having specialized hardware and/or software as required.

In one embodiment, UI application 512 may communicatively and interactively generate a UI for an AI agent implemented through the arithmetic reasoning generation module 430 (e.g., an LLM agent) at server 530. In at least one embodiment, a user operating user device 510 may enter a user utterance, e.g., via text or audio input, such as a question, uploading a document, and/or the like via the UI application 512. Such user utterance may be sent to server 530, at which arithmetic reasoning generation module 430 may generate a response via the process described in FIGS. 2A, 2B, and 3. The arithmetic reasoning generation module 430 may thus cause a display of a response (e.g., 316) based on a user query and an image at UI application 512 and interactively update the display in real time with the user utterance.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view the response for the user query and the image.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including 318 to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the arithmetic reasoning generation module 430 and its submodules described in FIG. 4A. In some implementations, arithmetic reasoning generation module 430 may receive data from database 519 at the data vendor server 545 via the network 560 to generate response (e.g., 316). The generated response may also be sent to the user device 510 for review by the user 540 via the network 560.

In one embodiment, an AI agent implementing the arithmetic reasoning generation module 430 and its submodules described in FIG. 4A may be built based on an LLM/VLM as described in FIG. 4B. For example, the AI agent may be configured with one or more LLMs and/or VLMs (e.g., each pretrained for a specific task or domain), a plurality of system prompts, and connected to external APIs to databases and applications (e.g., a search engine, a cloud service, an internal database, etc.).

In some embodiments, the AI agent implementing the arithmetic reasoning generation module 430 and its submodules described in FIG. 4A may be implemented as a cloud-based AI agent which may be accessed by user device 510 via a chatbot application, a web application, customer support or SaaS applications. In another implementation, a client-side AI agent component may be delivered from the server 530 to user device 510 for local installation such that the client-side AI agent may be installed and runs directly on the user's device. Such local AI agent on the user device 510 may be available offline to adapt to privacy-sensitive applications. In another implementation, the AI agent implementing the arithmetic reasoning generation module 430 and its submodules described in FIG. 4A may adopt a hybrid cloud and client-based structure to balance computing speed, cost and privacy. For example, a local AI agent may handle basic AI queries locally, but complex queries may be sent to server 530 to process.

The database 532 may be stored in a transitory and/or non-transitory memory of the server 530. In one implementation, the database 532 may store data obtained from the data vendor server 545. In one implementation, the database 532 may store parameters of the arithmetic reasoning generation module 430. In one implementation, the database 532 may store previously generated training data, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Work Flows

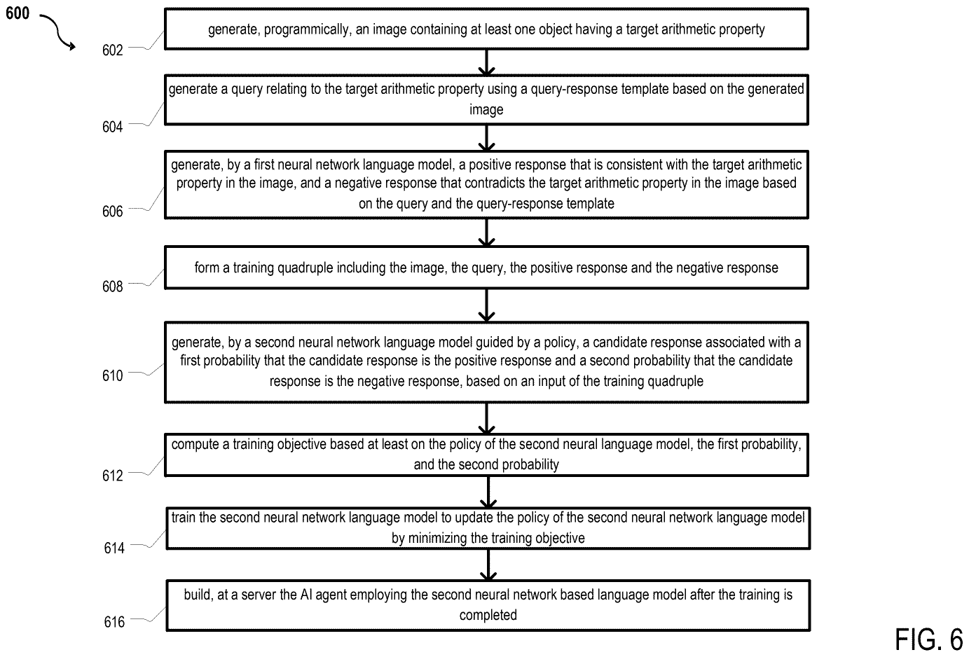

FIG. 6 is an example logic flow diagram illustrating a method of arithmetic reasoning generation based on the framework shown in FIGS. 2A, 2B, and 3, according to some embodiments described herein. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the arithmetic reasoning generation module 430 (e.g., FIGS. 4A and 5) that performs training a VLM and building an AI agent based on the VLM.

In some embodiments, method 600 is performed by a system such as computing device 400, user device 510, server 530, or another device or combination of devices. Inputs (e.g., input code 202) may be received via a data interface such as data interface 415, network interface 517, network interface 533, or via a data interface that is integrated with a device. For example UI Application 512 may receive user inputs via a text input interface (e.g., keyboard), audio input (e.g., microphone), video interface (e.g., camera), or other interface for receiving user inputs (e.g., a mouse or touch display).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 602, an image containing at least one object having a target arithmetic property is generating programmically. In some embodiments, the target arithmetic property includes one or more of a volume, a distance, a length, a slope, an angle, a position, an intersection, or quantity of the at least one object.

At step 604, a query relating to the target arithmetic property is generated using a query-response template based on the generated image. In some embodiments, the query-response template includes a text description of the image having one or more fields to be populated by the target arithmetic property.

At step 606, a positive response that is consistent with the target arithmetic property in the image, and a negative response that contradicts the arithmetic property in the image are generating, by a first neural network language model, based on the query and the query-response template. In some embodiments, the positive response is generated by populating the query-response template with correct values relating to the target arithmetic property based on a ground truth of the image, and the negative response is generated by populating the query-response template with incorrect values relating to the target arithmetic property based on the ground truth. In some embodiments, the target arithmetic property includes a comparison between multiple objects when the image includes the multiple objects.

At step 608, a training quadruple including the image, the query, the positive response and the negative response is formed.

At step 610, a candidate response is generated by a second neural network language model guided by a policy. The candidate response is associated with a first probability that the candidate response is the positive response and a second probability that the candidate response is the negative response, based on an input of the training quadruple.

At step 612, a training objective is computed based at least on the policy of the second neural language model, the first probability, and the second probability.

At step 614, the second neural network language model is trained to update the policy of the second neural network language model by minimizing the training objective. In some embodiments, the training of the second neural network based language model includes a direct preference optimization (DPO) that causes the second neural network based language model to maximize the first probability over the second probability.

At step 616, the AI agent employing the second neural network based language model is built at a server after the training is completed.

In some embodiments, method 600 further includes generating a second training quadruple including the image, a second query, a second positive response, and a second negative response. The second query and the query may relate to a same target arithmetic property of the image, but have different wording.

In some embodiments, method 600 further includes generating a second training quadruple including the image, a second query, a second positive response, and a second negative response. The second query may relate to a different target arithmetic property than the target arithmetic property that the query relates to.

In some embodiments, method 600 is applicable in a variety of applications. For example, the task request received by a neural network model (e.g., LLaVA-OV-0.5B, InternVL-2.5-MPO-1B, InternVL-2.5-MPO-4B) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 600, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 600 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

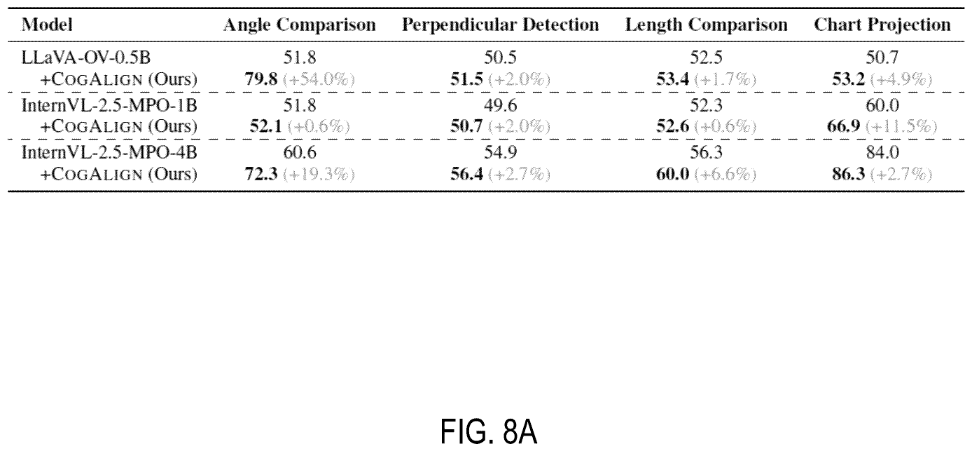

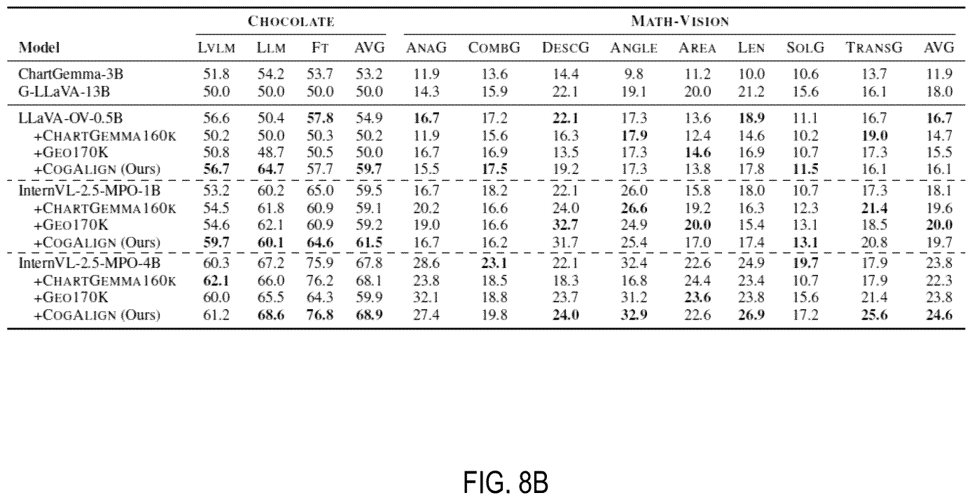

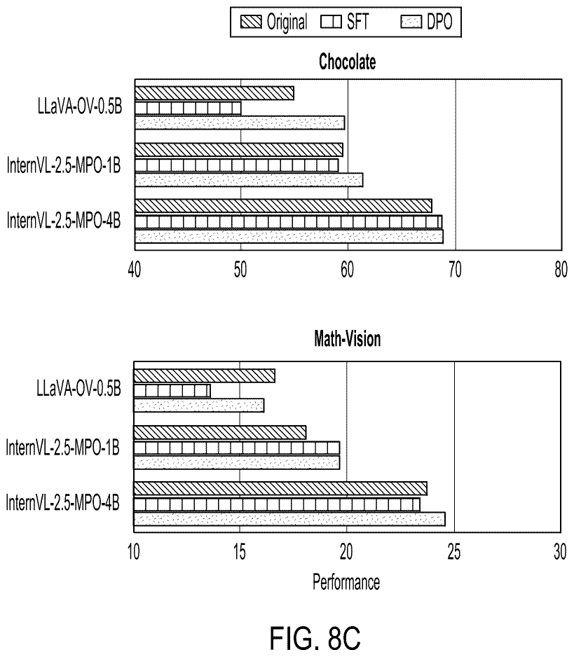

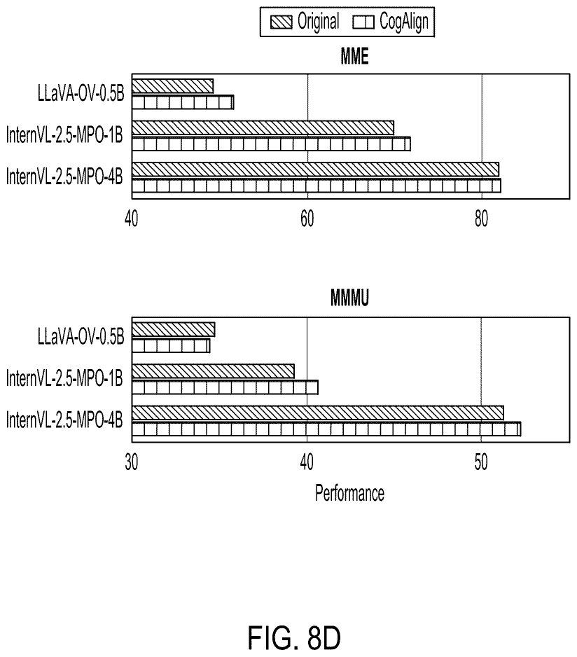

FIGS. 8A-8D represent exemplary test results using embodiments described herein.

To assess the effectiveness of the disclosed arithmetic reasoning generation framework on the proposed probing tasks, three VLMs are trained with varying scales and architectures: LLaVA-OV-0.5B (Bo Li, Yuanhan Zhang, Dong Guo, Renrui Zhang, Feng Li, Hao Zhang, Kaichen Zhang, Yanwei Li, Ziwei Liu, and Chunyuan Li. 2024. Llava-onevision: Easy visual task transfer.), InternVL-2.5-MPO-1B (Weiyun Wang, Zhe Chen, Wenhai Wang, Yue Cao, Yangzhou Liu, Zhangwei Gao, Jinguo Zhu, Xizhou Zhu, Lewei Lu, Yu Qiao, and Jifeng Dai. 2024b. Enhancing the reasoning ability of multimodal large language models via mixed preference optimization), and InternVL-2.5-MPO-4B using COGALIGN, e.g., training dataset 318, for one epoch. The results are presented in FIG. 8A.

It is observed that COGALIGN demonstrably improves performance across all three models across all probing tasks. More significant gains are observed on simpler tasks of Angle Comparison, likely due to their similarity with the DPO training instances. For instance, LLaVA-OV-0.5B sees a substantial 54.0% improvement on Angle Comparison after training with COGALIGN. This highlights the effectiveness of the disclosed approach in enhancing the core visual arithmetic capabilities that are crucial for these tasks. Interestingly, while the gain in angle-related tasks like Angle Comparison was substantial, the performance increases for Perpendicularity Detection were more modest (e.g., a 2.0% improvement for LLaVA-OV-0.5B). This suggests that certain geometric properties, such as perpendicularity, may pose greater challenges.

Overall, these findings collectively demonstrate the effectiveness of COGALIGN in enhancing visual arithmetic capabilities across various VLMs.

Now that the advantage of COGALIGN is demonstrated on the disclosed probing tasks. Whether COGALIGN enhances model performance in chart understanding and geometric problem-solving is explored to answer the question “does the improvement on simple visual arithmetic tasks transfer to more complex tasks?” Details of the research are described below.

The effectiveness of the disclosed method on two tasks relevant to visual arithmetic is evaluated: chart understanding and geometry problem solving. For chart understanding, the CHOCOLATE dataset (Kung-Hsiang Huang, Mingyang Zhou, Hou Pong Chan, Yi Fung, Zhenhailong Wang, Lingyu Zhang, Shih-Fu Chang, and Heng Ji. 2024c. Do LVLMs understand charts? analyzing and correcting factual errors in chart captioning. In Findings of the Association for Computational Linguistics: ACL 2024, pages 730-749, Bangkok, Thailand) is used. This dataset tests a model's capability to determine whether a given caption is factually consistent with its corresponding chart. CHOCOLATE comprises three splits: LVLM, LLM, and FT, each generated by models of varying architectures and scales. Each CHOCOLATE instance is annotated with a binary label [symbol] ∈{consistent, inconsistent}. The dataset includes a total of 1,187 chart-caption pairs. For geometry problem-solving, performance using the test set of the MATH-VISION dataset (Ke Wang, Junting Pan, Weikang Shi, Zimu Lu, Houxing Ren, Aojun Zhou, Mingjie Zhan, and Hongsheng Li. 2024a. Measuring multimodal mathematical reasoning with MATH-vision dataset. In The Thirty-eight Conference on Neural Information Processing Systems Datasets and Benchmarks Track.) is assessed. This dataset comprises 3,040 questions spanning 16 mathematical disciplines. The eight disciplines related to geometry are concentrated on: analytic geometry (ANAG), combinatorial geometry (COMBG), descriptive geometry (DESCG), solid geometry (SOLG), transformation geometry (TRANSG), and three metric geometry branches—angle, area, and length. For evaluations, AUC score is employed for CHOCOLATE and accuracy for MATH-VISION, in alignment with Huang et al. (Kung-Hsiang Huang, Mingyang Zhou, Hou Pong Chan, Yi Fung, Zhenhailong Wang, Lingyu Zhang, Shih-Fu Chang, and Heng Ji. 2024c. Do LVLMs understand charts? analyzing and correcting factual errors in chart captioning. In Findings of the Association for Computational Linguistics: ACL 2024, pages 730-749, Bangkok, Thailand) and Wang et al. (Ke Wang, Junting Pan, Weikang Shi, Zimu Lu, Houxing Ren, Aojun Zhou, Mingjie Zhan, and Hongsheng Li. 2024a. Measuring multimodal mathematical reasoning with MATH-vision dataset. In The Thirty-eight Conference on Neural Information Processing Systems Datasets and Benchmarks Track).

To assess the efficacy of COGALIGN compared to methods that directly optimize model capabilities towards specific tasks, a chart supervised fine-tuning dataset is considered: CHARTGEMMA 160K (Ahmed Masry, Megh Thakkar, Aayush Bajaj, Aaryaman Kartha, Enamul Hoque, and Shafiq Joty. 2024.Chartgemma: Visual instruction-tuning for chart reasoning in the wild.), as well as one geometric problem-solving dataset: GEO170K (Jiahui Gao, Renjie Pi, Jipeng Zhang, Jiacheng Ye, Wan-jun Zhong, Yufei Wang, Langing HONG, Jianhua Han, Hang Xu, Zhenguo Li, and Lingpeng Kong. 2025.G-LLaVA: Solving geometric problem with multi-modal large language model. In The Thirteenth International Conference on Learning Representations.). The above methods are used to train three open-source VLMs for one epoch: InternVL2.5-1B-MPO (Weiyun Wang, Zhe Chen, Wenhai Wang, Yue Cao, Yangzhou Liu, Zhangwei Gao, Jinguo Zhu, Xizhou Zhu, Lewei Lu, Yu Qiao, and Jifeng Dai. 2024b. Enhancing the reasoning ability of multimodal large language models via mixed preference optimization.), InternVL2.5-4B-MPO (Weiyun Wang, Zhe Chen, Wenhai Wang, Yue Cao, Yangzhou Liu, Zhangwei Gao, Jinguo Zhu, Xizhou Zhu, Lewei Lu, Yu Qiao, and Jifeng Dai. 2024b. Enhancing the reasoning ability of multimodal large language models via mixed preference optimization.), and LLaVA-OV-0.5B (Bo Li, Yuanhan Zhang, Dong Guo, Renrui Zhang, Feng Li, Hao Zhang, Kaichen Zhang, Yanwei Li, Ziwei Liu, and Chunyuan Li. 2024. Llava-onevision: Easy visual task transfer.). Performance of two VLMs instruction-tuned are compared specifically for chart understanding and geometric problem-solving: ChartGemma-3B (Ahmed Masry, Megh Thakkar, Aayush Bajaj, Aaryaman Kartha, Enamul Hoque, and Shafiq Joty. 2024.Chartgemma: Visual instruction-tuning for chart reasoning in the wild.) and G-LLaVA-13B Jiahui Gao, Renjie Pi, Jipeng Zhang, Jiacheng Ye, Wan-jun Zhong, Yufei Wang, Langing HONG, Jianhua Han, Hang Xu, Zhenguo Li, and Lingpeng Kong. 2025.G-LLaVA: Solving geometric problem with multi-modal large language model. In The Thirteenth International Conference on Learning Representations.).

The results for experiments on CHOCOLATE and MATH-VISION are shown in FIG. 8B. It is found that COGALIGN is effective in enhancing chart understanding and geometric problem-solving capabilities of VLMs even though COGALIGN was not specifically optimized for these two tasks. On average, COGALIGN boosts the performance by 4.6% and 2.9% on the CHOCOLATE and MATH-VISION datasets, respectively. This shows that patching fundamental capabilities such as visual arithmetic of VLMs can enhance their capabilities in tasks involving such abilities.

More importantly, It is found that COGALIGN demonstrates better generalizability compared to supervised fine-tuning VLMs using task specific data. For instance, when comparing the InternVL-2.5-MPO-1B variants, COGALIGN achieves an average score of 61.5% on CHOCOLATE, outperforming both the CHARTGEMMA 160K (59.1%) and GEO170K (59.2. %) variants. Similarly, on the MATH-VISION dataset, while the GEO 170K variant shows competitive performance, COGALIGN achieves a comparable average performance across all geometry subtasks, indicating a broader improvement. Notably, COGALIGN requires only 60% less training data compared to these two baseline methods.

The results suggest that COGALIGN offers a valuable approach to enhancing VLMs by improving their fundamental visual arithmetic capabilities. It exhibits strong generalizability across different tasks and base models, often outperforming or achieving comparable performance to task specific fine-tuning methods without being explicitly trained on the target datasets. This highlights the potential of focusing on foundational skills to unlock broader capabilities in VLMs.

The impact of learning from contrasting examples versus solely positive examples is investigated by comparing DPO (the default COGALIGN setting) and SFT training method (using only the positive response). FIG. 8C presents the results. It is observed that the SFT approaches can lead to much worse performance (e.g. LLaVA-OV-0.5B), while the DPO approach improves performance over the original models more consistently. This suggests that learning from contrasting examples provides a richer learning signal compared to traditional supervised learning, leading to better performance.

To assess the impact of COGALIGN on general VLM capabilities, the performance on two additional benchmarks are compared: MME (Chaoyou Fu, Peixian Chen, Yunhang Shen, Yulei Qin, Mengdan Zhang, Xu Lin, Zhenyu Qiu, Wei Lin, Jin-rui Yang, Xiawu Zheng, Ke Li, Xing Sun, and Ron-grong Ji. 2023.MME: A comprehensive evaluation benchmark for multimodal large language models) and MMMU (Xiang Yue, Yuansheng Ni, Tianyu Zheng, Kai Zhang, Ruoqi Liu, Ge Zhang, Samuel Stevens, Dongfu Jiang, Weiming Ren, Yuxuan Sun, Cong Wei, Botao Yu, Ruibin Yuan, Renliang Sun, Ming Yin, Boyuan Zheng, Zhenzhu Yang, Yibo Liu, Wenhao Huang, Huan Sun, Yu Su, and Wenhu Chen. 2024.MMMU: A massive multi-discipline multimodal understanding and reasoning benchmark for expert AGI. In IEEE/CVF Conference on Computer Vision and Pattern Recognition, CVPR 2024, Seattle, WA, USA, Jun. 16-22, 2024, pages 9556-9567. IEEE). The results are presented in FIG. 8D. Overall, COGALIGN consistently improves performance across most settings (five out of six), indicating that its benefits extend beyond the specific probing tasks and generalize to other multimodal reasoning challenges. This suggests that COGALIGN enhances visual arithmetic capabilities without compromising performance on general tasks.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of arithmetic reasoning generation by an artificial intelligence (AI) agent, comprising:
generating, programmically, an image containing at least one object having a target arithmetic property;
generating a query relating to the target arithmetic property using a query-response template based on the generated image;
generating, by a first neural network language model, a positive response that is consistent with the target arithmetic property in the image, and a negative response that contradicts the target arithmetic property in the image based on the query and the query-response template;
forming a training quadruple including the image, the query, the positive response and the negative response;
generating, by a second neural network language model guided by a policy, a candidate response associated with a first probability that the candidate response is the positive response and a second probability that the candidate response is the negative response, based on an input of the training quadruple;
computing a training objective based at least on the policy of the second neural language model, the first probability, and the second probability;
training the second neural network language model to update the policy of the second neural network language model by minimizing the training objective; and
building, at a server the AI agent employing the second neural network based language model after the training is completed.

2. The method of claim 1, wherein the target arithmetic property includes one or more of a volume, a distance, a length, a slope, an angle, a position, an intersection, or quantity of the at least one object.

3. The method of claim 1, wherein the query-response template comprise a text description of the image having one or more fields to be populated by the target arithmetic property.

4. The method of claim 3, wherein the positive response is generated by populating the query-response template with correct values relating to the target arithmetic property based on a ground truth of the image, and the negative response is generated by populating the query-response template with incorrect values relating to the target arithmetic property based on the ground truth.

5. The method of claim 1, wherein the target arithmetic property includes a comparison between multiple objects when the image includes the multiple objects.

6. The method of claim 1, further comprising generating a second training quadruple including the image, a second query, a second positive response, and a second negative response, wherein:
the second query and the query relate to a same target arithmetic property of the image, but have different wording.

7. The method of claim 1, further comprising generating a second training quadruple including the image, a second query, a second positive response, and a second negative response, wherein:
the second query relates to a different target arithmetic property than the target arithmetic property that the query relates to.

8. The method of claim 1, wherein the training of the second neural network based language model comprises a direct preference optimization (DPO) that causes the second neural network based language model to maximize the first probability over the second probability.

9. A system for arithmetic reasoning generation by an artificial intelligence (AI) agent, the system comprising:
a memory that stores a first neural network language model and a second neural network language model and a plurality of processor executable instructions;
a communication interface that receives instructions for generating an image containing at least one object having a target arithmetic property; and
one or more hardware processors that read and execute the plurality of processor-executable instructions from the memory, wherein the plurality of processor-executable instructions are configurable to cause the system to perform operations comprising:
generating, programmically, the image containing at least one object having the target arithmetic property;
generating a query relating to the target arithmetic property using a query-response template based on the generated image;
generating, by a first neural network language model, a positive response that is consistent with the target arithmetic property in the image, and a negative response that contradicts the target arithmetic property in the image based on the query and the query-response template;
forming a training quadruple including the image, the query, the positive response and the negative response;
generating, by a second neural network language model guided by a policy, a candidate response associated with a first probability that the candidate response is the positive response and a second probability that the candidate response is the negative response, based on an input of the training quadruple;
computing a training objective based at least on the policy of the second neural language model, the first probability, and the second probability;
training the second neural network language model to update the policy of the second neural network language model by minimizing the training objective; and
building, at a server the AI agent employing the second neural network based language model after the training is completed.

10. The system of claim 9, wherein the target arithmetic property includes one or more of a volume, a distance, a length, a slope, an angle, a position, an intersection, or quantity of the at least one object.

11. The system of claim 9, wherein the query-response template comprise a text description of the image having one or more fields to be populated by the target arithmetic property.

12. The system of claim 11, wherein the positive response is generated by populating the query-response template with correct values relating to the target arithmetic property based on a ground truth of the image, and the negative response is generated by populating the query-response template with incorrect values relating to the target arithmetic property based on the ground truth.

13. The system of claim 9, wherein the target arithmetic property includes a comparison between multiple objects when the image includes the multiple objects.

14. The system of claim 9, wherein the operations further include generating a second training quadruple including the image, a second query, a second positive response, and a second negative response, wherein:
the second query and the query relate to a same target arithmetic property of the image, but have different wording.

15. The system of claim 9, wherein the operations further include generating a second training quadruple including the image, a second query, a second positive response, and a second negative response, wherein:
the second query relates to a different target arithmetic property than the target arithmetic property that the query relates to.

16. The system of claim 9, wherein the training of the second neural network based language model comprises a direct preference optimization (DPO) that causes the second neural network based language model to maximize the first probability over the second probability.

17. A non-transitory machine-readable medium comprising a plurality of instructions, executable by one or more processors, wherein the plurality of instructions are configurable to cause the one or more processors to perform operations comprising:
generating, programmically, an image containing at least one object having a target arithmetic property;
generating a query relating to the target arithmetic property using a query-response template based on the generated image;
generating, by a first neural network language model, a positive response that is consistent with the target arithmetic property in the image, and a negative response that contradicts the target arithmetic property in the image based on the query and the query-response template;
forming a training quadruple including the image, the query, the positive response and the negative response;
generating, by a second neural network language model guided by a policy, a candidate response associated with a first probability that the candidate response is the positive response and a second probability that the candidate response is the negative response, based on an input of the training quadruple;
computing a training objective based at least on the policy of the second neural language model, the first probability, and the second probability;
training the second neural network language model to update the policy of the second neural network language model by minimizing the training objective; and
building, at a server the AI agent employing the second neural network based language model after the training is completed.

18. The non-transitory machine-readable medium of claim 17, wherein the target arithmetic property includes one or more of a volume, a distance, a length, a slope, an angle, a position, an intersection, or quantity of the at least one object.

19. The non-transitory machine-readable medium of claim 17, wherein the query-response template comprise a text description of the image having one or more fields to be populated by the target arithmetic property.

20. The non-transitory machine-readable medium of claim 19, wherein the positive response is generated by populating the query-response template with correct values relating to the target arithmetic property based on a ground truth of the image, and the negative response is generated by populating the query-response template with incorrect values relating to the target arithmetic property based on the ground truth.
